(19) United States
(12) Patent Application Publication
(10) Pub. No.: US 2013/0276338 A1
(43) Pub. Date: Oct. 24, 2013

(54) TIRE TAG FOR IDENTIFYING TIRE MOUNTING LOCATION

(71) Applicant: Mike AMARAL, ERIN (CA)

(72) Inventor: Mike AMARAL, ERIN (CA)

(21) Appl. No.: 13/850,850

(22) Filed: Mar. 26, 2013

Related U.S. Application Data
(60) Provisional application No. 61/615,548, filed on Mar. 26, 2012.
(60) Provisional application No. 61/648,423, filed on May 17, 2012.

(51) Int. Cl. G09F 3/04

(52) U.S. Cl. CPC G09F 3/04
USPC 40/299.01

(57) ABSTRACT

A tire tag for identifying mounting locations of a tire. The tire tag includes a base plate and at least one attachment portion extending outwardly from the base plate. The base plate has an upper surface, and markings showing a mounting location of the tire are provided on the upper surface of the base plate. The attachment portion is configured for removable attachment to an air valve of the tire.

### FIELD OF THE INVENTION

This invention relates to tire tags, and in particular, tire tags for identifying the mounting location of the wheel.

### BACKGROUND OF THE INVENTION

When wheels are removed from a car, the mounting location of the wheel needs to be identified. This is typically done by marking the wheel or tire with stickers, chalk, grease pen, marker or other writing instruments. The purpose of identifying the mounting location is for the installer to know where the wheel was removed from so that it may be remounted in the exact same location, or “rotated” to a new location determined by the tire or vehicle manufacturer. This is important for achieving even tire wear. Even tire wear is always desirable to maximize the life of the tire.

Currently, marking the wheel is usually carried out with writing instruments or stickers. These marking methods have many drawbacks and limitations, for example:
1. If the wheel is dirty, the writing instrument or sticker will not properly adhere to the writing surface.
2. Identification by a writing instrument or sticker can be easily removed by unintentional abrasion.
3. Often wheels are cleaned before being put into storage. Ideally, the wheel mounting location is identified BEFORE the wheel is removed from the vehicle to prevent improper location identification. Washing the wheel after it has been marked may remove part or all of the location identification markings.
4. Legibility of the location identification markings is subject to the “writers” ability to write clearly. The person that remounts the wheel may not be able to accurately read or interpret the markings, thus preventing proper location remounting.
5. There are no specifications or standards for terminology used to identify wheel mounting positions. Thus the installer may have difficulties interpreting the marking used by the “writer” at the time of removal.

Any of the above situations will prevent the installer from knowing exactly where the wheel was previously located, thus the installer will not be able to remount the wheel in the proper location.

Accordingly it would be advantageous to provide a device that can be used to identify wheel mounting positions without the shortcomings experienced with the currently available methods.

### SUMMARY OF THE INVENTION

The present invention is an identification tag (referred to as a “tire tag”) that is used to identify the original mounting location of the wheel on a vehicle. The tire tag comprises:

a base plate having an upper surface,

markings on the upper surface, said markings including a mounting location of the tire on a vehicle; and

at least one attachment portion extending outwardly from the base plate,

wherein the at least one attachment portion is configured for releasable attachment to an air valve of the tire.

In one embodiment of the tire tag, the attachment portion comprises an opening for releasably receiving a stem of the air valve.

In another embodiment, the attachment portion comprises a pair of flexible arms configured for wrapping around the stem of the air valve and gripping the stem.

In another embodiment, the tire tag includes two attachment portions, each extending from an opposing distal end of the base plate. In this embodiment, one of the two attachment portions may comprise an opening for releasably receiving a stem of the air valve, and the other attachment portion may comprise a pair of flexible arms configured for wrapping around the stem of the air valve and gripping said stem.

Further features of the invention will be described or will become apparent in the course of the following detailed description.

### BRIEF DESCRIPTION OF THE DRAWING

The invention will now be described by way of example only, with reference to the accompanying drawing, in which:

FIG. 1 is a perspective view of a tire tag according to one embodiment of the present invention;

FIG. 2 is to show the tire tag of FIG. 1 in use, where the tag is attached to an air valve stem of the tire;

FIG. 3 is a top view of a tire tag according to an alternative embodiment of the present invention;

FIG. 4 is a top view of a tire tag according to another alternative embodiment of the present invention; and

FIG. 5 is a side view of the tire tag shown in FIG. 4.

### DETAILED DESCRIPTION OF THE INVENTION

Embodiments of the present invention provide tire tags for identifying the mounting location of the wheel. The tag has a base plate having an upper surface; markings on the upper surface which show the mounting location of the tire on a vehicle; and at least one attachment portion extending outwardly from the base plate, wherein said at least one attachment portion is configured for releasable attachment to an air valve of the tire.

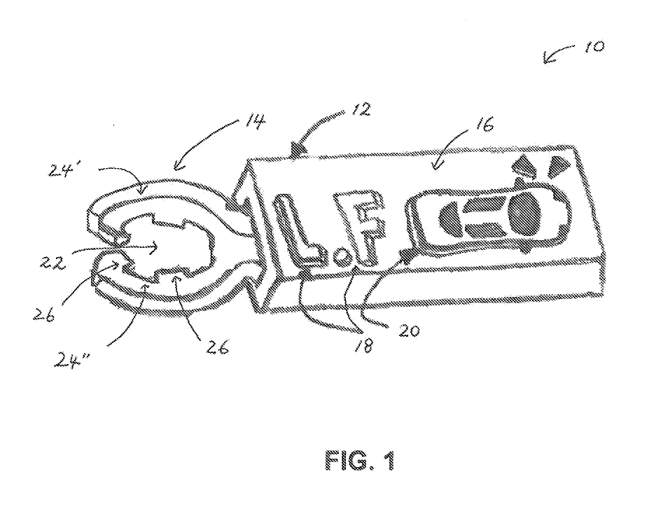

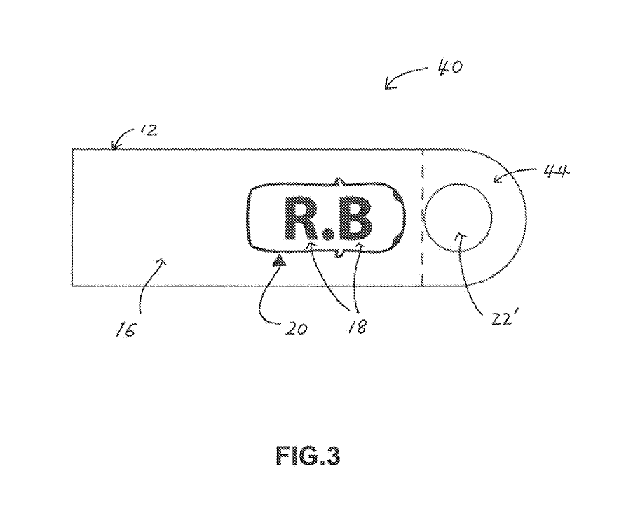

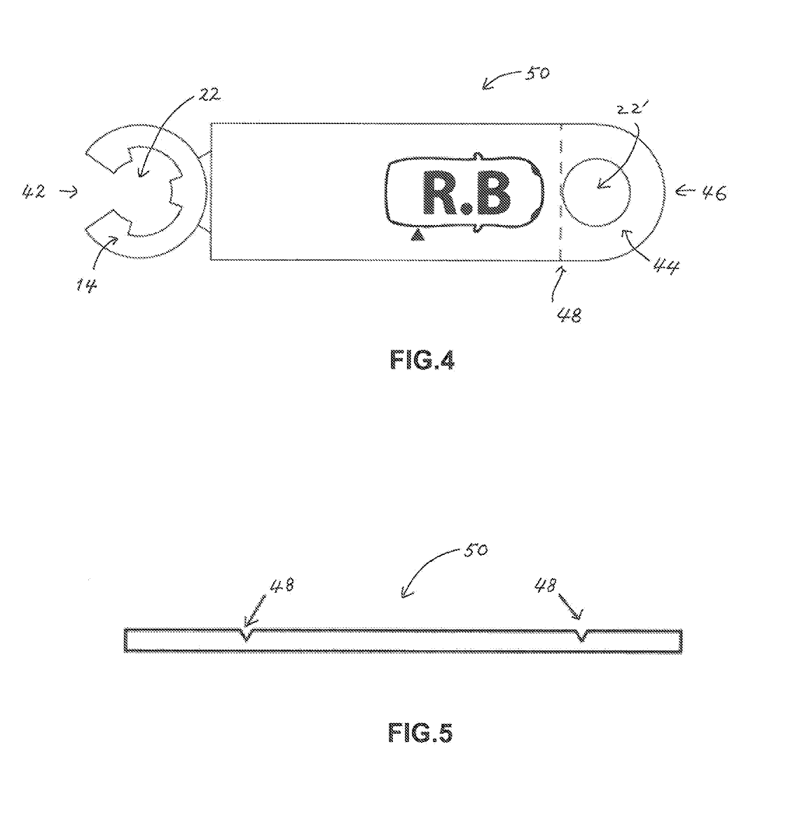

The attachment portion has an opening that allows the tag to be releaseably attached to the valve stem of the wheel. According to one embodiment, the opening may be configured such that the tag may be clipped (see for example, FIG. 1) onto the air valve. According to another embodiment, the opening may be configured in the form of a hole, such that the tag may be slipped (see for example FIG. 3) onto the air valve. In another embodiment, the tire tags may have two attachment portions, each extending from opposing distal ends of the base plate (see for example, FIG. 4 which includes both the “clip end” and the “hole end”).

The present invention will be further illustrated using the following exemplary, non-limiting embodiments with references drawings.

Referring to FIG. 1, the tire tag according to one embodiment of the present invention is shown generally at 10. Preferably, the tag is made of plastic. The tire tag 10 has the base plate 12 and attachment portion 14. The base plate 12 has an upper surface 16 having the wheel mounting position markings 18 and 20. The markings 18 and 20 may be molded into the base plate 12 or imprinted with permanent ink. The attachment portion 14 has an opening 22 that allows the tag to be releaseably attached to the valve stem of the wheel.

The markings used to identify the mounting position will be in both written 18 and pictorial forms 20 thus making interpretation by the installer unmistakable. Optionally the base plate 12 may have advertising on the backside of the plate, but it will be understood that the message has nothing to do with the function of the tag, it is just for advertising purposes. The advertising may be on the front or back of the tag.

Typically four tire tags, each one with specific markings to identify distinct mounting locations, can be used per application. FIG. 1 shows one example of the pictorial marking 20 pointing to left front side of the wheel, along with its written marking 18 using the abbreviation “L.F.” This is one illustrative form of markings, and many various and alternative forms of markings may be used according to the present invention. For example, the right/rear side of the wheel may be marked by using the abbreviation “R.R.” (i.e., right rear), or by way of a different abbreviation “R.B” (i.e., right back), or any other form of markings that can be identified as intended orientations. A further challenge is that wheels and tires come in different designs, shapes and sizes. However, the tire air valve stem is reasonably consistent in dimension and every wheel is equipped with one. In particular, the threaded portion of the tire air valve stem where the tire valve cap is installed is the same diameter for all wheels.

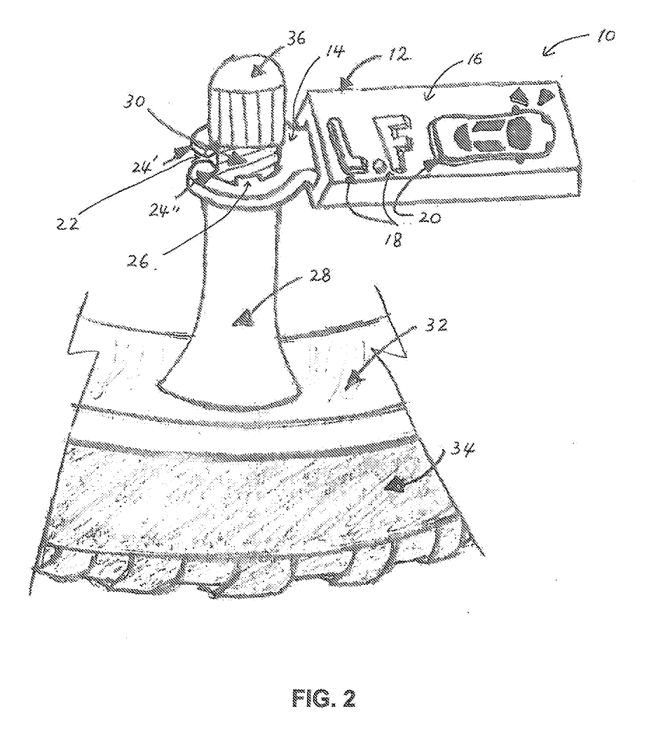

Referring to FIG. 2, the tire tag 10 is designed to be installed onto the tire air valve stem 28. FIG. 2 shows the tire at 34 and rim at 32 through which the air valve stem 24 extends outwardly. The tire tag 10 can be installed anywhere along the length of the tire air valve stem 28. In one preferred embodiment, attachment portion 14 of the tire tag 10 is installed around the threaded portion 30 of the tire air valve stem 28 or just below where the threads end. As noted above, the tire tag 10 can be made of plastic material, which provides the opening 22 with flexibility such that the tag can readily be slipped or clipped onto the air valve stem 28. In one embodiment as shown in FIG. 1, the opening 22 of the attachment portion 14 is defined by a pair of flexible arms 24′ and 24″. The flexible arms 24′ and 24″ may further include molded protrusions 26 that provide additional security for releasable attachment to the air valve stem 28. In another embodiment, the opening 22 may be a hole as shown in FIG. 3 which allows the tag to be slipped onto the air valve stem 28. The design of the attachment portion 14 may vary within the scope of the invention to accommodate different shapes and diameters of the air valve stems.

In a preferred embodiment the tag 10 is made from plastic so that the arms 24′ and 24″ are flexible. This flexibility allows the tag 10 to be installed anywhere on the stem as long as the diameter of the stem 28 does not exceed the flexible limits of the tag opening. Valves come in different shapes, some taper and change diameter right after the threads, others do not so that by having the arms 24′ and 24″ flexible, the present tag can accommodate a variety stems of different shape and sizes.

To attach the tire tag 10, removal of the tire air valve cap 36 (if present) may not be necessary. The attachment portion 14 of the tire tag will have an opening 22 to allow it to be clipped onto the valve stem. The design of the tire tag will prevent the tag from falling off unintentionally, while allowing spinning on the valve. The tire tag can be removed from the stem by applying enough force to alleviate the grip around the stem 28. For example, the tag 10 can be removed from the air valve 28 stem by exerting hand grip.

Referring to FIG. 3, another embodiment of a tire tag according to the present invention is shown at 40. The tire tag 40 is similar to the tire tag 10, except that it has an attachment portion 44 provided with an opening 22′ that allows the tag to be slipped onto the air valve stem. As shown in FIG. 3, opening 22′ is a hole whose diameter is slightly larger than the diameter of the treaded portion of the valve stem. For example, with a standard tire valve stem having a diameter of about 0.300 inches (0.762 cm), the hole 22′ in the tag 40 may be configured to have a diameter of approximately 0.310 inches (0.775 cm). It is to be noted that a different range of sizes can be used for the hole 22′, provided that it is large enough to fit onto the tire valve stem, but smaller than the tire valve cap. The tire valve cap will hold the tire tag 40 securely in place, thus preventing it from being taken off. To remove the tire tag 40, the tire valve cap will need to be unscrewed, thus allowing the tire tag 40 to be slipped off the tire valve stem.

Referring to FIG. 4, a tire tag according to another embodiment of the present invention is shown at 50. The tire tag 50 has two attachment portions 14 and 44 extending from opposing distal ends of the base plate 16. The tire tag 50 provides users with an option of choosing either the clip end 42 or the hole end 46. If the users do not require one of the ends, they could simply snap it off. For this option, the attachment portions 14 and 44 may be configured for ready removal from the tire tag. FIG. 5 is a side view of the tag 50 showing the score or break lines 48 that may be moulded into the plastic. The score lines are used to assist with breaking the ends of the tag off. The user may need to do this if the tag is too long and additional clearance is needed to install the tag. The removal of the attachment portions may be carried out by different methods, for example, notches and perforations.

The tire tags according to the present invention eliminate all shortcomings currently experienced with any existing method of wheel mounting location identification. Some of the advantages achieved from the tire tags of the present invention are:
1. “Tire Tags” can be installed before the wheel is removed from the car, thus preventing improper identification.
2. “Tire Tags” are made from plastic thus cannot be washed off the wheel during cleaning.
3. Mounting position identification is permanently applied to the plastic “Tire Tag” thus eliminating the risk of being washed off or removed by unintentional abrasion.
4. “Tire Tag” mounting location markings are clearly imprinted on the tags avoiding any illegibility issues.
5. “Tire Tag” mounting location markings are in BOTH written and pictorial form thus preventing any interpretation problems.

The tire tags of the present invention are an effective way to quickly and easily identify the proper location to remount the wheel thus maximizing the life expectancy of the tire.

Generally speaking, the invention described herein is directed to tire tags for identifying the proper location for mounting the wheel. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to tire tags for identifying the mounting location of the wheel.

As used herein, the terms “comprises” and “comprising” are to construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

Therefore what is claimed is:

1. A tire tag for identifying mounting location of a tire on a vehicle, comprising:
a base plate having an upper surface,
markings on the upper surface, said markings including a mounting location of the tire on a vehicle; and
at least one attachment portion extending outwardly from the base plate,
wherein said at least one attachment portion is configured for releasable attachment to an air valve of the tire.

2. The tire tag according to claim 1 wherein the attachment portion comprises an opening for releasably receiving a stem of the air valve.

3. The tire tag according to claim 1 wherein the attachment portion comprises a pair of flexible arms configured for wrapping around a stem of the air valve and gripping said stem.

4. The tire tag according to claim 3 wherein the pair of flexible arms have inwardly extending protrusions.

5. The tire tag according to any one of claim 1 wherein said at least one attachment portion is two attachment portions, each extending from an opposing distal end of the base plate.

6. The tire tag according to claim 5 wherein one of the two attachment portions comprises an opening for releasably receiving a stem of the air valve.

7. The tire tag according to claim 5 wherein one of the two attachment portions comprises a pair of flexible arms configured for wrapping around a stem of the air valve and gripping said stem.

8. The tire tag according to claim 5 wherein one of the two attachment portions comprises an opening for releasably receiving a stem of the air valve, and the other of the two attachment portions comprises a pair of flexible arms configured for wrapping around the stem of the air valve and gripping said stem.

9. The tire tag according to claim 7 wherein the pair of flexible arms have inwardly extending protrusions.

10. The tire tag according to claim 8 wherein the pair of flexible arms have inwardly extending protrusions.

11. The tire tag according to claim 5 wherein the attachment portions are configured for being removable from the base plate.

12. The tire tag according to claim 11 wherein the attachment portions comprise one of notches, break lines, perforation, and a combination thereof, whereby the attachment portions are removed from the base plate.

13. The tire tag according to claim 8 wherein the attachment portions are configured for being removable from the base plate.

14. The tire tag according to claim 1 wherein said markings are selected from the group consisting of written markings, pictorial markings, and a combination thereof.

15. The tire tag according to claim 1 wherein the base plate is made of plastic.

16. The tire tag according to claim 15 wherein the markings are molded into the plastic base plate.

17. The tire tag according to claim 1 wherein the markings are imprinted with ink.

18. A tire tag for identifying mounting location of a tire on a vehicle, comprising:
a base plate having an upper surface,
markings on the upper surface, said markings including a mounting location of the tire on a vehicle; and
a first and a second attachment portions extending from each opposing distal end of the base plate;
wherein said attachment portions are configured for releasable attachment to an air valve of the tire.

19. The tire tag according to claim 18 wherein the first attachment portion comprises an opening for releasably receiving a stem of the air valve.

20. The tire tag according to claim 18 wherein the second attachment portions comprises a pair of flexible arms configured for wrapping around a stem of the air valve and gripping said stem.
